(19) United States
(12) Patent Application Publication
(10) Pub. No.: US 2003/0179572 A1
(43) Pub. Date: Sep. 25, 2003

(54) LED utility light

(76) Inventor: Tim Schnell, Bedford, TX (US)

Correspondence Address: SCHWEGMAN, LUNDBERG, WOESSNER & KLUTH, P.A., P.O. BOX 2938, MINNEAPOLIS, MN, 55402, US

(21) Appl. No.: 10/100,495

(22) Filed: Mar. 19, 2002

(51) Int. Cl. F21L 4/04

(52) U.S. Cl. 362/191; 362/198; 362/287; 362/427; 362/98

(57) ABSTRACT

A utility light includes a base, an arm coupled to the base, and a headlamp coupled to the arm. The headlamp itself includes an LED, a power source to power the LED, and a switch to control the LED. The base can be adapted to be clipped to a page and adapted to support the arm and headlamp when the base is placed onto a flat surface.

### FIELD OF THE INVENTION

This invention relates to the field of lights, and more specifically to portable utility lights.

### BACKGROUND

Small utility lights such as flashlights and booklights are useful when light is needed temporarily in a specific place. Flashlights are typically hand-held and it is difficult to position such a light precisely where it is needed without continually holding and manipulating the light. Conventional booklights allow for some handsfree positioning. A typical booklight includes a base clip for attaching to a book, an arm extending from the base, and a light connected to the arm. These booklights usually have batteries mounted within the base clip to power the light, or a cord is run from the light to a separate power pack or to an outlet. The movement of the headlamp of such booklights is constrained by the size and weight of the booklights and the need to run the electrical wires up to the headlamp. The wires can become fatigued or damaged if bent or twisted, so the arm and headlamp movement is usually constrained by designers. Moreover, present booklights are typically useful only for that purpose and are not readily adapted for use as utility lights for other purposes.

### SUMMARY

The present invention provides a utility light which includes a base, an arm coupled to the base, and a headlamp coupled to the arm. The headlamp includes an LED, a power source to power the LED, and a switch to control the LED. By incorporating the LED, power source, and switch into the headlamp itself, the present utility light allows the arm and head lamp to be movably connected to the base and to each other without damaging any connection wires. Moreover, the base can be relatively small and lightweight since it does not need to hold any batteries. In some examples, the arm can be a telescoping member and can be rotatably coupled to the base. In one example, the head lamp can rotate at least 180 degrees relative to the arm and can swivel 360 degrees. In one example, the arm can include a flexible, stiffened wire structure.

### BRIEF DESCRIPTION OF THE DRAWINGS

FIG. 1 shows a perspective view of a utility light according to one embodiment.

FIG. 2 shows a cross-section of the headlamp of the utility light of FIG. 1.

FIG. 3 shows an end view of the utility light of FIG. 1.

FIG. 4 shows a side view of the utility light of FIG. 1.

FIG. 5 shows the utility light of FIG. 1 in a folded configuration.

FIG. 6 shows the utility light of FIG. 1 mounted on a page of a book.

FIG. 7 shows a perspective view of a utility light according to one embodiment.

FIG. 8 shows the utility light of FIG. 7 in a folded configuration.

FIG. 9 shows a perspective view of a utility light according to one embodiment.

### DETAILED DESCRIPTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that other embodiments may be utilized and that structural changes may be made without departing from the scope of the present invention. Therefore, the following detailed description is not to be taken in a limiting sense, and the scope of the present invention is defined by the appended claims and their equivalents.

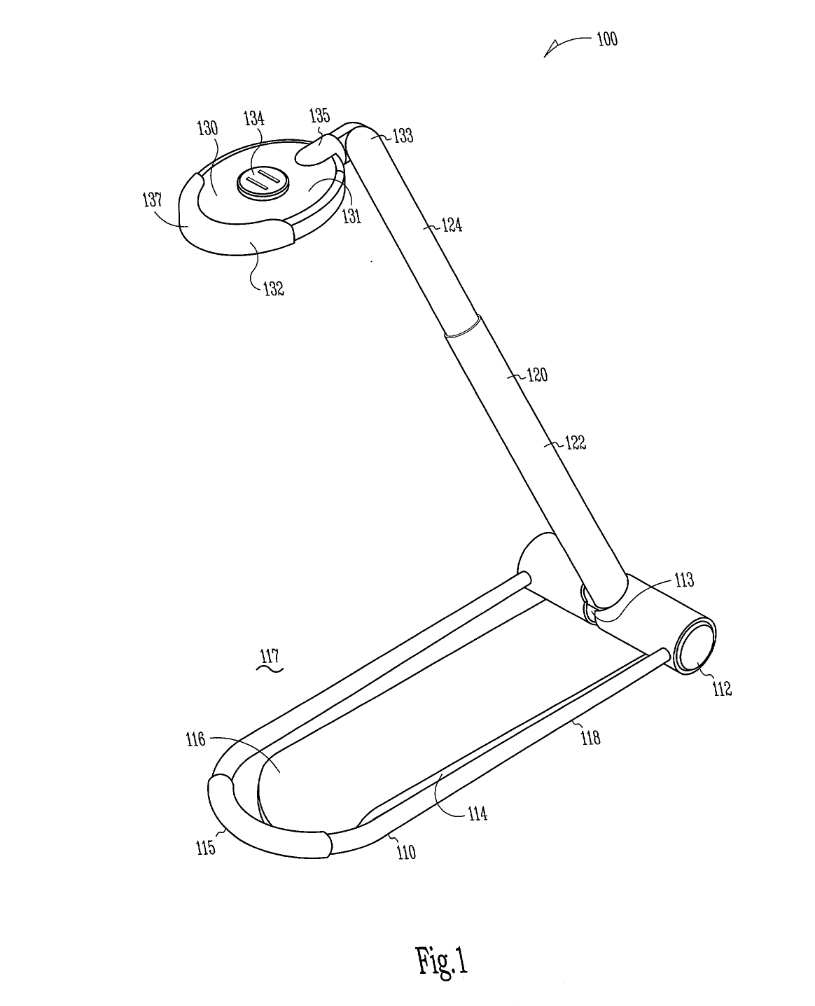

FIG. 1 shows a perspective view of a utility light 100 according to one embodiment. Utility light 100 includes a base 110, an elongated arm 120, and a headlamp 130.

Base 110 includes a support section 112 and a mounting section 114. Base 110 supports utility light 100 on a surface such as a table surface 117 or clipped to something, such as a book, as will be discussed below. In one example, mounting section 114 includes a clip structure which includes a tongue member 116 connected to and extending from support section 112 and a U-shaped member 118 also connected to extending from support section 112. Tongue member 116 and U-shaped member 118 are concentric, cantilevered members with U-shaped member 118 surrounding and offset from tongue member 116. In one embodiment, a grip section 115 is provided at one end of U-shaped member 118 to provide extra friction to keep the base from slipping.

Members 116 and 118 act like opposing leaf springs when something is placed between them, allowing them to grip or be clipped to the object. This allows utility light 100 to be used as a book-light, with one or more pages of the book disposed between the members 116 and 118. Moreover, members 116 and 118 extend a distance from support section 112 to provide an elongated support area for the utility light. This allows utility light 100 to be placed on almost any surface, allowing the light to be used as a lamp or temporary light fixture.

Arm 120 has one end rotatably attached to support section 112 of base 110. A grooved portion 113 in support section 112 allows arm 120 to rotate back and forth relative to base 110. In this example, arm 120 is a rigid, elongated member including a first shaft 122 and a second shaft 124. First and second shafts 122 and 124 are telescoped together, allowing second shaft 124 to move axially within first shaft 122. Thus, a user can raise or lower headlamp 130 as needed by extending and shortening the arm. In other embodiments, three or more shafts can be telescoped together to form arm 120. In some embodiments, a single non-telescoping shaft is used.

Headlamp 130 is connected to a second, distal end of arm 120. Headlamp 130 is a generally flattened structure having a generally oval shape from a top view with generally flat top and bottom surfaces. This allows the utility light to be easily stored and transported since it creates such a compact size when folded. Headlamp 130 includes a main body 131 which has mounted thereto a light source such as a light emitting diode (LED) 132 which is used as a light source for utility light 100. A clear or at least partially transparent cover 137 is provided to protect and diffuse the light from the light source. Headlamp 130 can vary in size. In one example the headlamp has the approximate dimensions of approximately 1.5 inches long, 1 inch wide, and ½ inch thick.

In this example, LED 132 is a white LED, which provides a desirable light for reading. Other LEDs, such as red, yellow, etc. can also be used with the present utility light. An LED allows for a much smaller, more compact lamphead than provided by typical booklights which use bulbous, screw-in lightbulbs which result in a relatively bulky, unwieldy lamphead. The LED of the present lamphead allows the lamphead shape and size to be compact and lightweight. LED 132 can be dimensioned as desired. In one example an LED is used having an approximately 5.0 mm diameter and a length of approximately 5.0 mm to 7.0 mm. Other sizes of LEDs can also be used and are within the scope of the present system.

A switch 134 is mounted to main body 131 to control a power connection to light source 132. In one example, headlamp 130 is configured such that the headlamp has two degrees of freedom. A joint 133 between headlamp 130 and arm 120 allows the headlamp to rotate back and forth relative to the arm. Headlamp 130 also includes a swivel joint 135 allowing the headlamp to swivel 360 degrees. Details of examples of these movements will be discussed below.

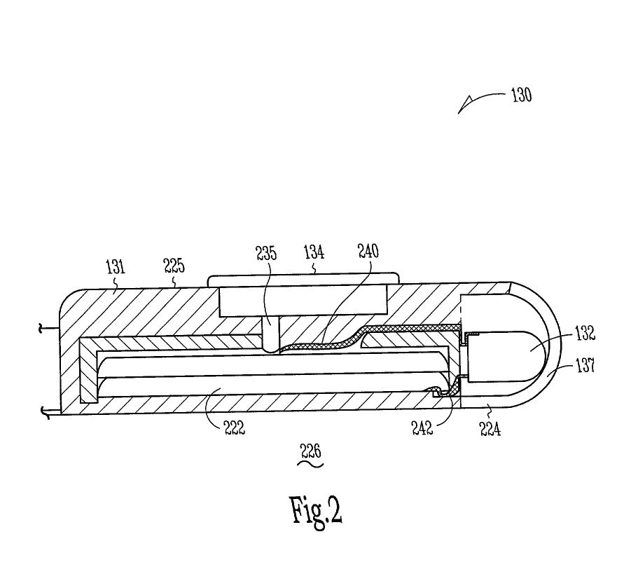

FIG. 2 shows a partial cross-section of headlamp 130 in accordance with one embodiment. Switch 134 is mounted to a top side 225 of the headlamp and light source 132 is mounted near a front portion. Light cover 137 wraps around the front end of the headlamp with a bottom portion 224 of the light cover being exposed along the bottom surface 226 of the headlamp.

In this example, headlamp 130 includes a power source 222 contained directly within the main body 131 of the headlamp. In one example, power source 222 includes two CR2016 batteries. These flat, lightweight batteries allow for the compact, flattened shape of headlamp 130. Power source 222 is connected by electrical connectors 240 and 242 to LED 132. Switch 134 includes an actuating portion 235 which is positioned to urge connector 240 into contact with power source 222 when the switch is actuated by sliding the switch in one direction. This completes the circuit and powers the light source. When the switch is slid the other direction, connector 240 moves away from the power source, thus breaking the circuit.

By positioning light source 132, power source 222, and switch 134 all within or on headlamp 130, the present utility light does not need to have any wires running up arm 120 or a separate power source connected to the light source, or bulky, heavy batteries stored within support section 112. This provides a light-weight, easily portable utility light. Moreover, the absence of wires and electrical connection between base 110, arm 120, and headlamp 130 allow the present utility light to be designed to be almost fully movable without constraints.

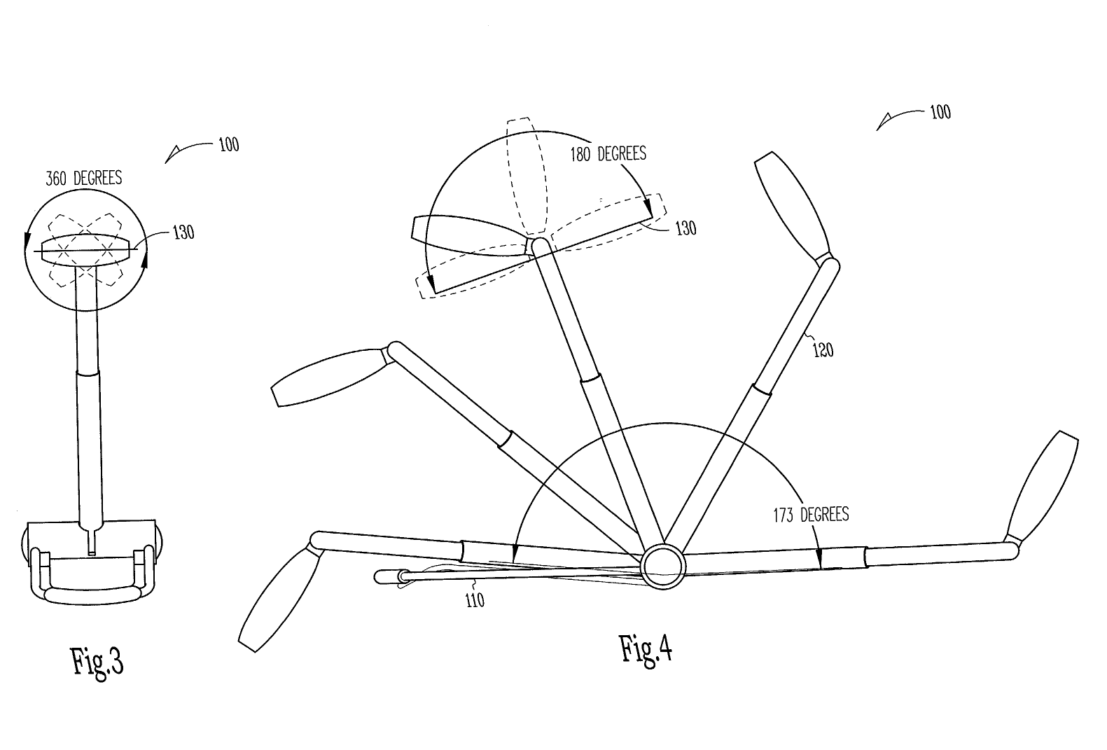

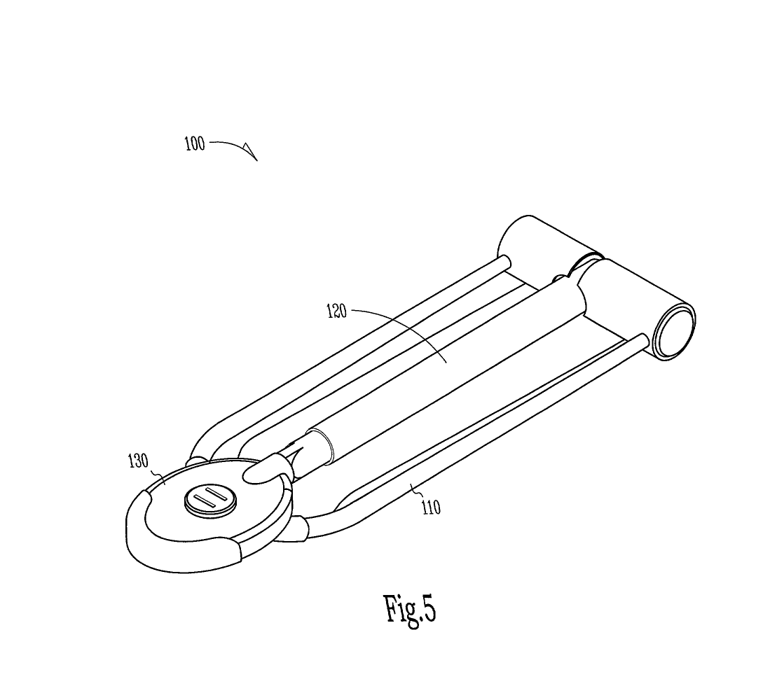

For example, FIGS. 3 and 4 show examples of movement made possible with the present design. FIG. 3 shows an end view of utility light 100, while FIG. 4 shows a side view of the utility light.

In FIG. 3, a longitudinal axis of headlamp 130 is perpendicular to the page, and the Figure shows how headlamp 130 is 360 degrees swivelable about its longitudinal axis. This allows a user to swivel, point, and maneuver the light however needed.

FIG. 4 shows one example of arm 120 having a range of approximately 173 degrees relative to base 110. In other embodiments, the arm can be configured to have almost any range of rotation since no electrical wires restrict a designer's choices. Accordingly, the arm can have a rotation of less than 173 degrees or greater than 173 degrees. In one example, headlamp 130 also has a back and forth rotation of approximately 180 degrees relative to arm 120. Moreover, the arm can also be extended, as described above.

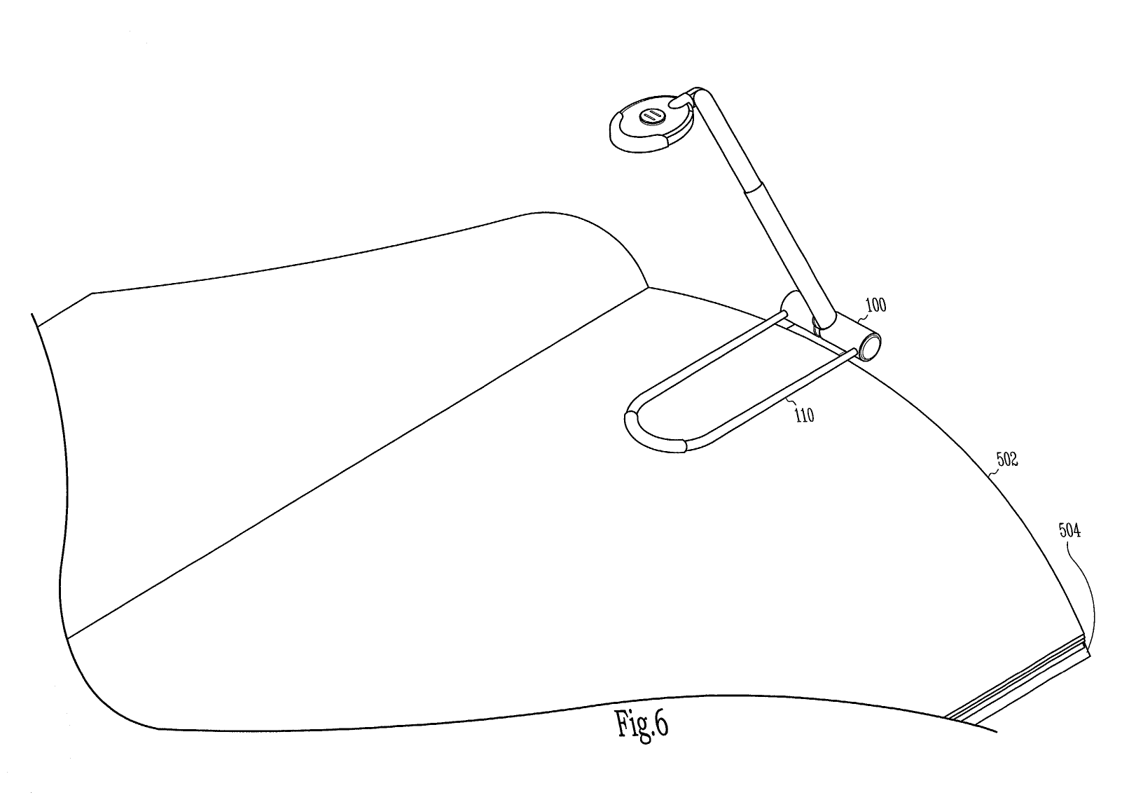

FIG. 5 shows utility light 100 in a folded configuration. Here, telescoping arm 120 has been closed, arm 120 has been rotated approximately 90 degrees from vertical such that the arm now flushly abuts base 110, and headlamp 130 has been rotated to be aligned with arm 120. In the present embodiment, the folded-up size of utility light 100 is approximately 11.0 cm long, 4.5 cm wide, and 1.6 cm high. This provides a very compact configuration which is easy to carry and store. Then, when needed, light 100 can be opened up and the arms and headlamp can be moved to almost any position without a user worrying about damaging any wires running through the body of the light.

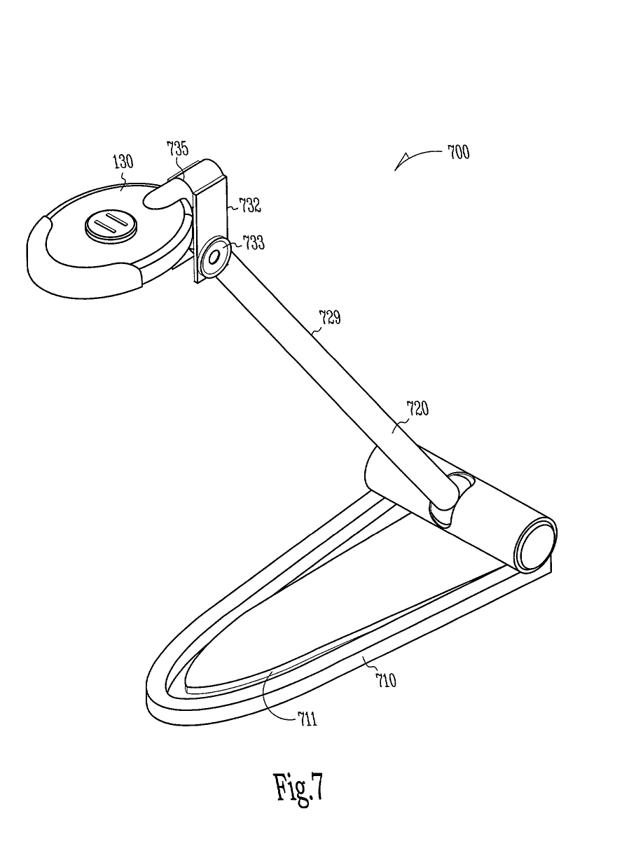

In one example use of utility light 100, FIG. 6 shows utility light 100 mounted on one or more pages 502 of a book 504. The present utility light 100 is well suited to being used as a booklight since base section 110 is easily clippable to pages 502, and since the light is so easily positionable. Moreover, by incorporating the power source and switch within headlamp 130, a user does not have to contend with unwieldy battery packs and cords. Utility light 100 is a complete, lightweight, package. Referring again to FIG. 1, light 100 can also be used on any surface 117 where base 110 provides support.

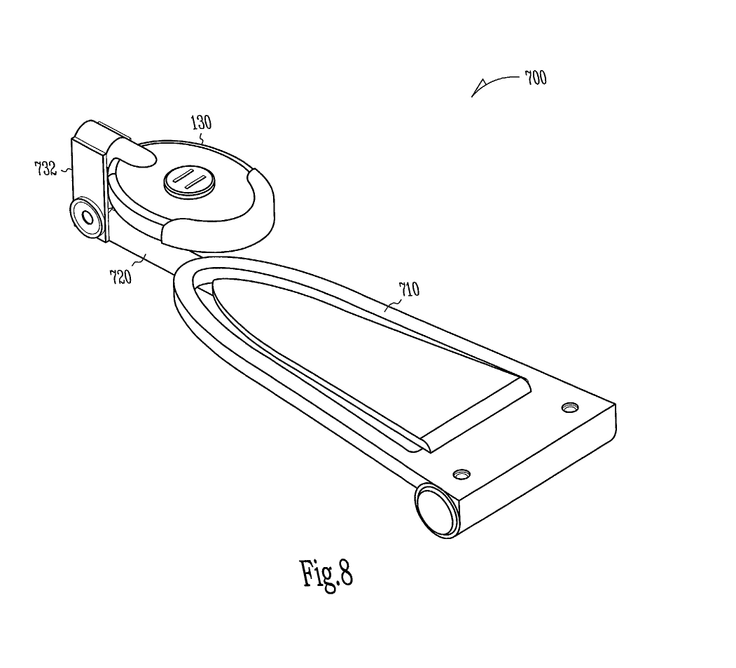

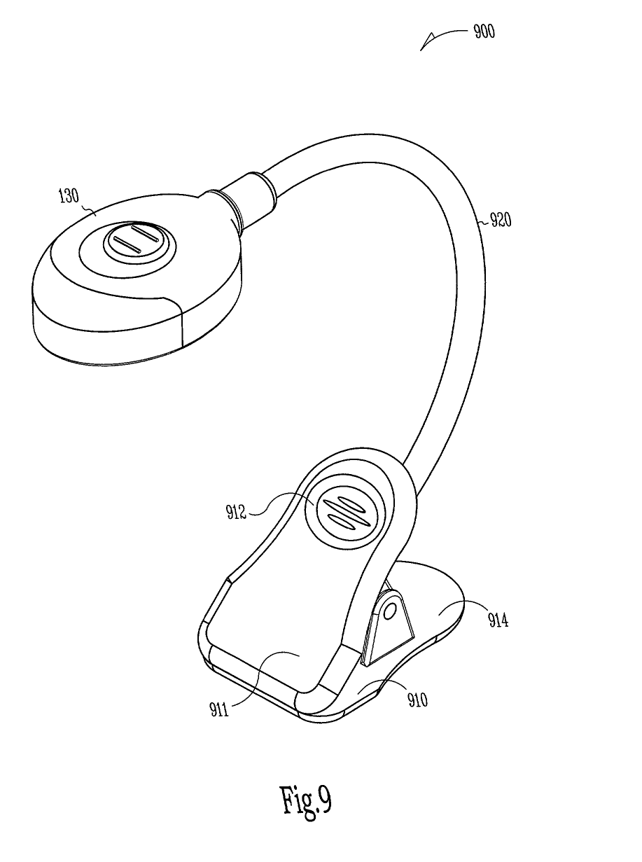

FIGS. 7 and 8 show a utility light 700 according to one embodiment. FIG. 7 shows a perspective view of utility light 700 and FIG. 8 shows utility light 700 in a folded configuration.

Utility light 700 includes a base 710, an elongated arm 720, and headlamp 130. Certain features of light 700, such as headlamp 130, are similar to those described above for light 100 and will not be described herein for sake of clarity.

In one embodiment, members 710 and 720 are molded plastic members. Base 710 includes a clip mounting section 711 similar to the mounting section described above for light 100. In this example, arm 720 includes a shaft 729 and an extension member 732. Shaft 729 is rotatably coupled at one end to base 710 and is rotatably coupled at a second end to extension member 732 at a pivot 733. Extension member 732 rotates enough relative to shaft 729 such that headlamp 130 can be positioned parallel with the shaft. This allows the light to be compactly folded (see FIG. 8), and it allows the light to be optimally positioned for reading. A swivel joint 735 between headlamp 130 and extension member 732 allows for a 360 degrees swivel action for the headlamp, similar to that discussed above for utility light 100.

As discussed above, by positioning a light source, power source, and switch all within or on headlamp 130, utility light 700 does not need to have any wires running up arm 720 or a separate power source connected to the light source, or bulky, heavy batteries stored within the base. This provides a light-weight, easily portable utility light. Moreover, the absence of wires and electrical connection between base 710, arm 720, and headlamp 130 allow the present utility light to be designed to be almost fully movable without constraints.

FIG. 9 shows a perspective view of a utility light 900 according to one embodiment. Utility light 900 includes a base 910, an elongated arm 920, and headlamp 130. Certain features of light 900, such as headlamp 130, are similar to those described above for light 100 and will not be described herein for sake of clarity.

Base 910 includes a clip member 911 having a first member 912 and a second member 914. These members 912 and 914 can be spring-loaded to bias the clip towards a closed position. A user squeezes the opposite ends of members 912 and 914 to open the jaws to engage the clip onto an object such as a book.

Elongated arm 920 includes a first end attached to base 910 and a second end attached to headlamp 130. In this example, elongated arm 920 includes a plastic covered wire structure. This wire structure includes a bendable wire which is stiff enough to hold its form yet flexible enough to be bent by hand. Arm 920 can be bent relative to base 910 and headlamp 130 can be moved relative to arm 920. This allows the headlamp to be moved to many different positions and configurations. In various embodiments, arm 920 can be approximately 2 inches, 3 inches, 4 inches, or more in length.

Again, by positioning a light source, power source, and switch all within or on headlamp 130, utility light 900 does not need to have any wires running up arm 920 or a separate power source connected to the light source, or bulky, heavy batteries stored within base 910. This provides a light-weight, easily portable utility light. Moreover, the absence of electrical wires and electrical connection between base 910, arm 920, and headlamp 130 allow the present utility light to be designed to be almost fully movable without constraints.

It is understood that the above description is intended to be illustrative, and not restrictive. Many other embodiments will be apparent to those of skill in the art upon reviewing the above description. The scope of the invention should, therefore, be determined with reference to the appended claims, along with the full scope of equivalents to which such claims are entitled.

What is claimed is:

1. A utility light comprising:
a base;
an elongated arm coupled to the base and movable relative to the base; and
a headlamp coupled to the arm, wherein the headlamp itself includes an LED, a power source connectable to the LED, and a switch to control a connection between the LED and the power source.

2. The utility light of claim 1, wherein the base includes clip.

3. The utility light of claim 1, wherein the base includes a support section having a tongue member extending from the support section and a U-shaped member extending from the support section and surrounding the tongue member.

4. The utility light of claim 1, wherein the base is adapted to be clipped to a page and is also adapted to support the arm and the headlamp when the base is placed onto a surface.

5. The utility light of claim 1, wherein the arm includes two or more shafts coupled together in a telescoping relationship.

6. The utility light of claim 1, wherein the arm is rotatably coupled to the base such that the arm can rotate at least approximately 173 degrees relative to the base.

7. The utility light of claim 1, wherein the elongated arm includes a bendable wire structure.

8. The utility light of claim 1, wherein the headlamp is rotatably coupled to the arm such that the headlamp can rotate at least approximately 180 degrees relative to a longitudinal axis of the arm.

9. The utility light of claim 1, wherein the headlamp is adapted to swivel 360 degrees about a longitudinal axis of the headlamp.

10. The utility light of claim 1, wherein the power source includes two CR2016 batteries.

11. The utility light of claim 1, wherein the headlamp comprises a flattened structure with the switch mounted to a top surface of the headlamp.

12. A utility light comprising:
a base;
an arm coupled to the base; and
a headlamp coupled to the arm and having a light source, power source, and switch mounted thereto, wherein the headlamp is adapted to swivel 360 degrees about a longitudinal axis of the headlamp.

13. The utility light of claim 12, wherein the power source includes one or more flat batteries mounted within the headlamp.

14. The utility light of claim 12, wherein the light source includes an LED.

15. The utility light of claim 12, wherein the base is adapted to be clipped to a page and is also adapted to support the arm and the headlamp when the base is placed onto a surface.

16. The utility light of claim 12, wherein the arm includes two or more shafts coupled together in a telescoping relationship.

17. The utility light of claim 12, wherein the arm is rotatably coupled to the base such that the arm can rotate at least approximately 173 degrees relative to the base.

18. The utility light of claim 12, wherein the headlamp is rotatably coupled to the arm such that the headlamp can rotate approximately at least 180 degrees relative to a longitudinal axis of the arm.

19. A utility light comprising:
a headlamp incorporating a light source, a power source for energizing the light source, and a switch for controlling a connection between the light source and the power source;
abase; and
an arm having a first end rotatably connected to the base and a second end rotatably connected to the headlamp;
wherein the utility light is foldable such that the utility light has a first, unfolded configuration and a second, folded configuration, wherein in the first unfolded configuration the arm is rotated a distance away from the base and the headlamp is rotated a distance away from the arm, and wherein in the second folded configuration the arm is rotated to abut the base, and the headlamp is rotated to be generally parallel relative to the arm.

20. The utility light of claim 19, wherein the arm includes a shaft coupled to the base and an extension member coupled to the headlamp, wherein the extension member is rotatably connected to the shaft.

21. The utility light of claim 19, wherein the arm is adapted to have a first, extended length and a second, shortened length and wherein in the first, unfolded configuration the arm has the first, extended length and in the second, folded configuration the arm has the second, shortened length,

22. The utility light of claim 19, wherein the base includes means for clipping the utility light to a book.

23. The utility light of claim 19, wherein the light source includes an LED.

24. The utility light of claim 19, wherein the headlamp is adapted to swivel 360 degrees about a longitudinal axis of the headlamp.

25. A utility light comprising:
a base clip for attaching the utility light to a book;
an arm having a first end coupled to the base clip, the arm being movable relative to the base;
a headlamp coupled to a second end of the arm, the headlamp movable relative to the arm, wherein the headlamp itself includes an LED, a power source connectable to the LED, and a switch to control a connection between the LED and the power source.

26. The utility light of claim 25, wherein the arm includes a telescoping structure.

27. The utility light of claim 25, wherein the headlamp is adapted to swivel 360 degrees about a longitudinal axis of the headlamp.

28. The utility light of claim 25, wherein the arm includes a bendable wire structure.
